(19) United States
(12) Patent Application Publication
(10) Pub. No.: US 2024/0337781 A1
(43) Pub. Date: Oct. 10, 2024

(54) POLARIZER, POLARIZER APPLICATION DEVICE, AND MANUFACTURING METHOD OF POLARIZER

(71) Applicant: Mitsubishi Electric Corporation, Tokyo (JP)

(72) Inventors: Hiroki KOBAYASHI, Tokyo (JP); Genki YAMASHITA, Tokyo (JP); Wataru TSUJITA, Tokyo (JP)

(73) Assignee: Mitsubishi Electric Corporation, Tokyo (JP)

(21) Appl. No.: 18/292,943

(22) PCT Filed: Aug. 3, 2021
(86) PCT No.: PCT/JP2021/028748

§ 371 Date: Jan. 29, 2024

(51) Int. Cl. G02B 5/30; B29D 11/00

(52) U.S. Cl. CPC G02B 5/3058; B29D 11/00644

(57) ABSTRACT

The disclosure concerns a polarizer that polarizes electromagnetic waves, and includes a plurality of carbon fibers and a holder that holds the plurality of carbon fibers in a state of being arranged with spacing between each other. The plurality of carbon fibers each include parts extending in the same direction.

### TECHNICAL FIELD

The present disclosure relates to a polarizer, a polarizer application device, and a manufacturing method of a polarizer.

### BACKGROUND ART

Electromagnetic waves in the terahertz (THz) frequency band (hereinafter referred to also as terahertz waves) are greatly counted on in terms of application to object detection or imaging, utilization for 6G (6th Generation) communication, and so forth. Since the terahertz waves are often used after being polarized into linearly polarized waves or circularly polarized waves, a polarizer for the terahertz waves is necessary for using the terahertz waves. For example, Patent Reference 1 proposes a polarizer for terahertz employing a wire grid including a plurality of metallic wires (e.g., tungsten wires) arrayed at constant intervals.

### PRIOR ART REFERENCE

### Patent Reference

Patent Reference 1: Japanese Patent Application Publication No. 2018-36517 (see paragraph 0031 and FIG. 1, for example)

### SUMMARY OF THE INVENTION

### Problem to be Solved by the Invention

However, the above-described conventional polarizer has a problem in that deterioration in polarization performance is likely to occur due to disconnection of a metallic wire or displacement of a metallic wire.

An object of the present disclosure is to provide a polarizer capable of stably maintaining its polarization performance, a polarizer application device including the polarizer, and a manufacturing method of the polarizer.

### Means for Solving the Problem

A polarizer in the present disclosure is a polarizer that polarizes electromagnetic waves, including a plurality of carbon fibers and a holder to hold the plurality of carbon fibers in a state of being arranged with spacing between each other. The plurality of carbon fibers respectively include parts extending in a same direction.

A manufacturing method of a polarizer in the present disclosure is a method of manufacturing a polarizer that polarizes electromagnetic waves, including a process of arranging a plurality of carbon fibers with spacing between each other so that the plurality of carbon fibers respectively include parts extending in a same direction and a process of fixing the plurality of carbon fibers.

A manufacturing method of a polarizer in the present disclosure is a method of manufacturing a polarizer that polarizes electromagnetic waves, including a process of arranging a plurality of carbon fibers oriented to respectively include parts extending in a same direction and a plastic raw material on a forming die, a process of molding the plastic raw material by applying pressure to the plurality of carbon fibers and the plastic raw material arranged on the forming die, a process of forming a molded object including the plurality of carbon fibers and a plastic part filling in spaces around the plurality of carbon fibers by curing the molded plastic raw material, and a process of demolding the molded object from the forming die.

### Effect of the Invention

According to the present disclosure, the polarization performance of the polarizer can be maintained stably.

### BRIEF DESCRIPTION OF THE DRAWINGS

FIG. 1 is a perspective view schematically showing the structure of a principal part of a polarizer according to a first embodiment.

FIG. 2 is a perspective view schematically showing the whole of the polarizer according to the first embodiment.

FIGS. 3A to 3C are schematic cross-sectional views showing an example of a manufacturing method of the polarizer shown in FIG. 1.

FIG. 4 is a flowchart showing an example of the manufacturing method of the polarizer shown in FIG. 1.

FIG. 5 is a perspective view schematically showing the structure of a polarizer according to a second embodiment.

FIG. 6 is a schematic cross-sectional view of the polarizer in FIG. 5 taken along the line VI-VI in FIG. 5.

FIG. 7 is a schematic cross-sectional view of the polarizer in FIG. 5 taken along the line VII-VII in FIG. 5.

FIGS. 8A to 8C are schematic cross-sectional views showing an example of a manufacturing method of the polarizer in FIG. 4.

FIG. 9 is a flowchart showing an example of the manufacturing method of the polarizer in FIG. 5.

FIG. 10 is a diagram showing a relationship among a polarization axis of the polarizer in FIG. 5, a fiber orientation direction and an oscillation direction.

FIG. 11 is a diagram showing a relationship between a polarization property and carbon fiber density of the polarizer in FIG. 5.

FIGS. 12A and 12B are schematic diagrams showing the configuration of an encoder as a polarizer application device according to a third embodiment.

FIG. 13 is a perspective view showing detailed structure of polarizers of the encoder shown in FIGS. 12A and 12B.

### MODE FOR CARRYING OUT THE INVENTION

A polarizer, a polarizer application device, and a manufacturing method of a polarizer according to each embodiment will be described below with reference to the drawings. The following embodiments are just examples and it is possible to appropriately combine embodiments and appropriately modify each embodiment.

Coordinate axes of an XYZ orthogonal coordinate system are shown in the drawings in order to facilitate the understanding of a relationship between drawings. An X-axis is a coordinate axis in an X direction as a direction in which each carbon fiber extends (i.e., orientation direction of carbon fibers). A Y-axis is a coordinate axis in a Y direction as a direction in which a plurality of carbon fibers are arrayed (i.e., array direction). A Z-axis is a coordinate axis in a Z direction as a direction in which electromagnetic waves are incident.

### First Embodiment

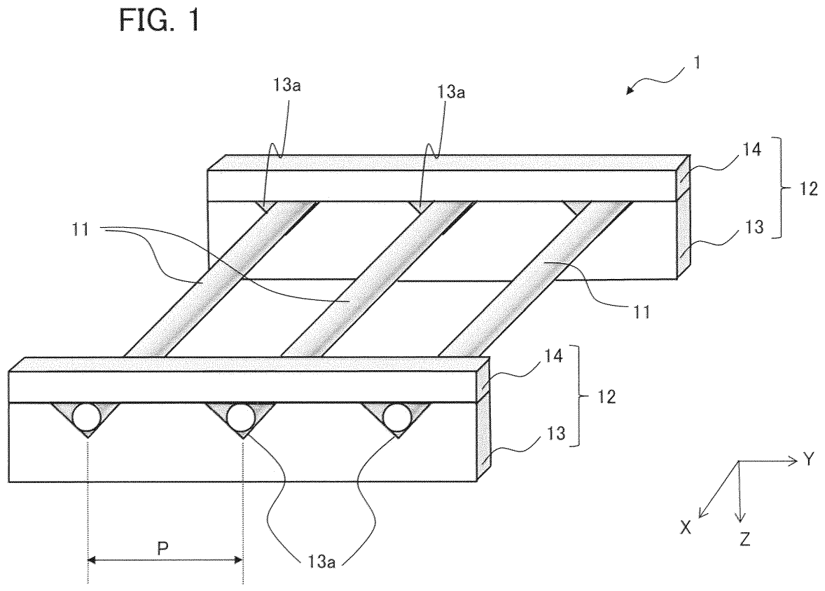

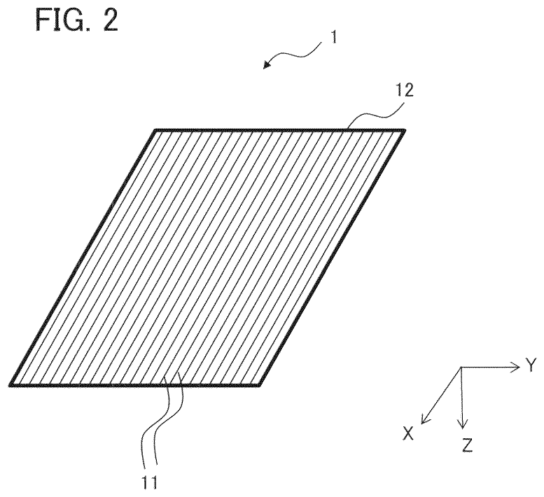

FIG. 1 is a perspective view schematically showing the structure of a principal part of a polarizer 1 according to a first embodiment. FIG. 2 is a perspective view schematically showing the whole of the polarizer 1. The polarizer 1 polarizes electromagnetic waves. The polarizer 1 has structure especially suitable for the polarization of terahertz waves traveling in the Z direction. The terahertz waves are electromagnetic waves with frequencies in a range of 0.1 THz to 10 THz (i.e., with wavelengths in a range of 30 μm to 3000 μm), for example.

As shown in FIG. 1, the polarizer 1 includes a plurality of carbon fibers 11 and a holding member 12 as a holder that holds the plurality of carbon fibers 11 in a state of being arranged with spacing between each other. The holding member 12 is usable also as a jig for holding the plurality of carbon fibers 11. The plurality of carbon fibers 11 are conductors respectively including parts extending in the same direction (the X direction in FIG. 1). FIG. 1 shows an example in which the plurality of carbon fibers 11 extend in the same X direction (i.e., in parallel with each other). While three carbon fibers are shown in FIG. 1 as the plurality of carbon fibers 11, the number of carbon fibers can be any number. Details of the carbon fibers used, such as the material, the size and the density of the carbon fiber, will be described in a second embodiment later.

The holding member 12 holds parts of the carbon fibers 11 nearby their ends. The holding member 12 includes a first member 13 having a plurality of grooves 13a respectively positioning the parts of the carbon fibers 11 nearby their ends and a second member 14 that presses against and fixes the plurality of carbon fibers 11 in the plurality of grooves 13a. The second member 14 is fixed to the first member 13 by using screws, an adhesive agent or the like, for example. While a pair of holding members 12 facing each other is shown in FIG. 1, the holding member 12 can be a frame-shaped member surrounding the plurality of parallelly arranged carbon fibers 11 as shown in FIG. 2.

In the example of FIG. 1, the array pitch of the plurality of grooves 13a (i.e., interval P between the lowest bottom parts of grooves 13a adjacent to each other) is a constant value. The constant value is determined depending on the wavelength of the terahertz waves handled. The interval P is desired to be set less than or equal to ¼ of the wavelength of the terahertz waves used. The plurality of carbon fibers 11 are arranged according to the interval P of the plurality of grooves 13a. In FIG. 1, the adjacent carbon fibers 11 are arranged at even intervals. However, the adjacent carbon fibers 11 may also be arranged at random intervals. In the case of arranging the plurality of carbon fibers 11 at even intervals, the wavelength of the terahertz waves to be polarized can be selected with high accuracy. In contrast, in the case of arranging the plurality of carbon fibers 11 at random intervals (i.e., in the case of employing structure tolerating a great error in the interval), productivity of the polarizer can be increased.

While V-shaped grooves are shown in FIG. 1 as the grooves 13a, the shape of the groove 13a is not limited to the illustrated shape. Further, while FIG. 1 shows the structure that sandwiches the carbon fibers 11 between the first member 13 and the second member 14 for fixing the carbon fibers 11, the fixation structure is not limited to the illustrated example. While both ends of each carbon fiber 11 are fixed by the grooves 13a in FIG. 1, it is also possible to leave one end suspended in the air without fixing the end.

The carbon fiber 11 is a member containing carbon as the principal component. An example of the carbon fiber 11 is a PAN (polyacrylonitrile)-based carbon fiber that is an acrylic fiber. Another example of the carbon fiber 11 is a pitch-based carbon fiber that is a fiber made by carbonating pitch (by-product of petroleum, coal, coal tar or the like) as the raw material at high temperatures. When the carbon fibers are chopped fibers or milled fibers that are discontinuous, it is difficult to array a plurality of carbon fibers 11 as shown in FIG. 1. However, when the carbon fibers are continuous fibers, it is possible to fix a plurality of carbon fibers 11 in the arrayed state by using the holding member 12. Further, the carbon fiber 11 has tensile strength of 3000 MPa-7000 MPa, and the tensile strength of the carbon fiber 11 is higher than those of metallic materials. Accordingly, the plurality of carbon fibers 11 are unlikely to break even when the grating of the polarizer 1 is formed as shown in FIG. 2, and thus the productivity of the polarizer 1 is more excellent compared to cases where the grating is formed with a metallic material.

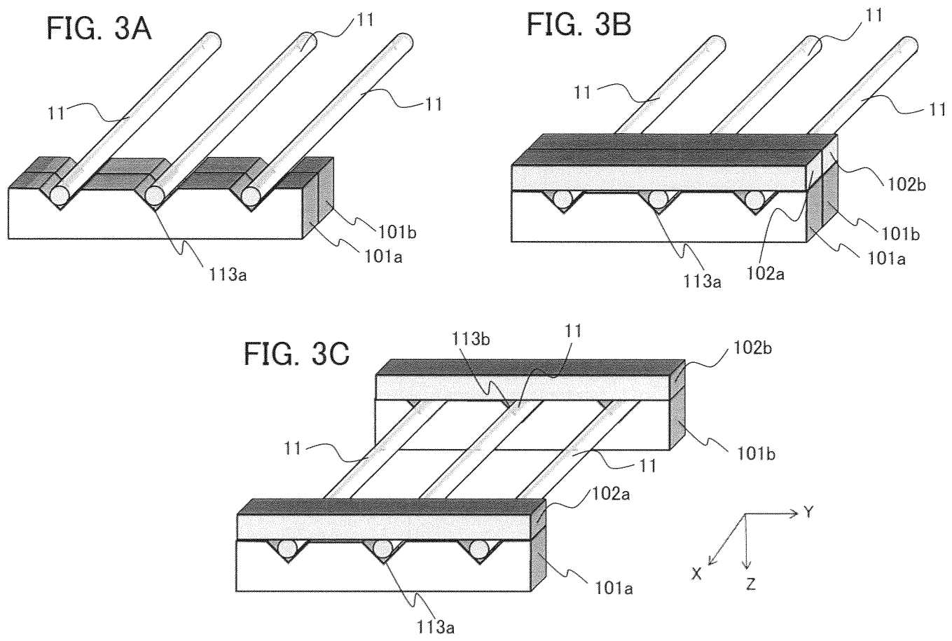

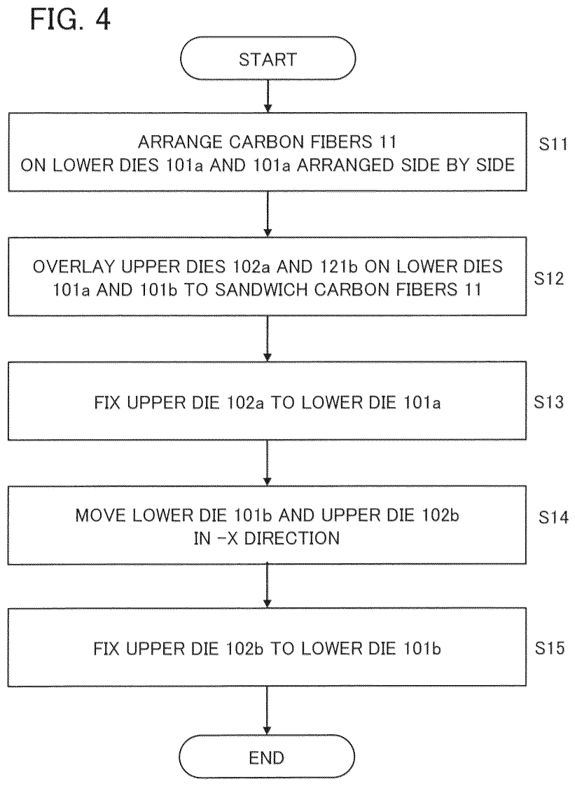

Next, a manufacturing method of the polarizer 1 will be described below. FIGS. 3A to 3C are schematic cross-sectional views showing an example of the manufacturing method of the polarizer 1. FIG. 4 is a flowchart showing an example of the manufacturing method of the polarizer 1. The manufacture of the polarizer 1 is carried out automatically by manufacturing equipment, for example.

First, as shown in FIG. 3A, a plurality of carbon fibers 11 are arranged with spacing between each other on lower dies 101a and 101b as two forming dies arranged side by side (i.e., the first member 13 in FIG. 1) (step S11). In FIG. 3A, the plurality of carbon fibers 11 are like wires and are arranged so that each of the plurality of carbon fibers 11 includes a part extending in the same direction (the X direction in FIG. 3A). In order to control the intervals between the plurality of carbon fibers 11, the lower die 101a is provided with grooves 113a (i.e., the grooves 13 in FIG. 1). The lower die 101b is provided with grooves 113b (i.e., the grooves 13 in FIG. 1) that are the same as the grooves 113a in the pitch and the shape.

Subsequently, upper dies 102a and 121b are respectively overlaid on the lower dies 101a and 101b (step S12), and the lower die 101a and the upper die 102a are fixed to each other (step S13). The fixation can be done by an appropriate method such as screwing or adhesion by using an adhesive agent; the method of the fixation is not limited.

Subsequently, the lower die 101b and the upper die 102b are simultaneously moved in the extending direction of the carbon fibers 11 (−X direction in FIG. 3) (step S14). Subsequently, the lower die 101b and the upper die 102b are fixed to each other (step S15). The fixation can be done by an appropriate method such as screwing or adhesion by using an adhesive agent; the method of the fixation is not limited. The polarizer 1 can be manufactured by the above-described process.

The polarizer 1 according to the first embodiment includes the plurality of carbon fibers 11 held by the holding member 12, and thus the strength can be increased and the polarizer 1 is unlikely to be damaged. Therefore, the polarizer 1 is capable of maintaining a stable polarization property.

### Second Embodiment

While the structure in which the plurality of carbon fibers 11 are held by the holding member 12 is described in the first embodiment, structure in which a plurality of carbon fibers are embedded in a plastic part will be described below in a second embodiment.

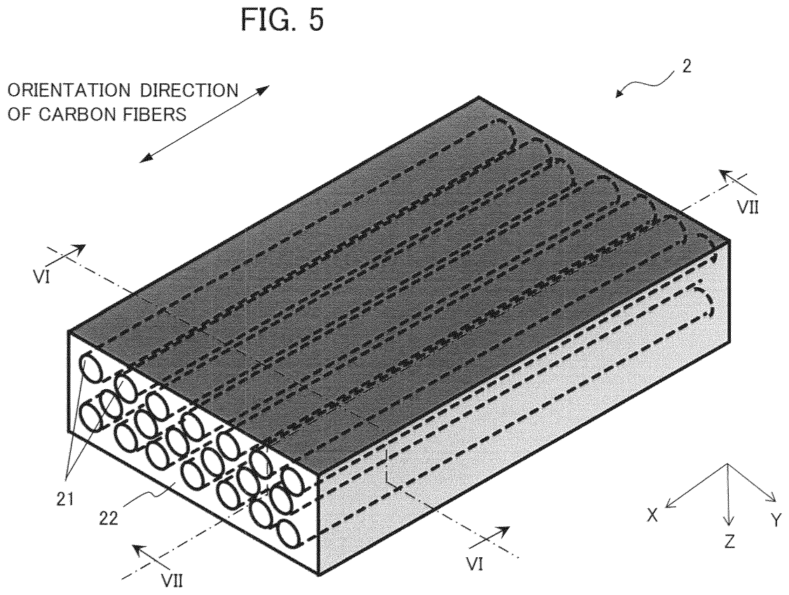

FIG. 5 is a perspective view schematically showing the structure of a polarizer 2 according to the second embodiment. The polarizer 2 polarizes electromagnetic waves. The polarizer 2 has structure especially suitable for the polarization of terahertz waves traveling in the Z direction.

As shown in FIG. 5, the polarizer 2 includes a plurality of carbon fibers 21 and a plastic part 22 as a holder that holds the plurality of carbon fibers 21 in a state of being arranged with spacing between each other. The plurality of carbon fibers 21 are conductors respectively including parts extending in the same direction (the X direction in FIG. 5). In other words, in the second embodiment, the plurality of carbon fibers 21 as the conductors are covered with the plastic part 22 as an insulator. FIG. 5 shows an example in which each of the plurality of carbon fibers 21 includes a part extending in the same X direction. While twenty carbon fibers are shown in FIG. 5 as the plurality of carbon fibers 21, the number of the plurality of carbon fibers can be any number.

The plastic part 22 keeps the plurality of carbon fibers 21 embedded therein. That is, in the second embodiment, the holder includes the plastic part 22 that keeps the plurality of carbon fibers 21 embedded therein. The plastic part 22 contains thermosetting epoxy resin, for example.

An example of the carbon fiber 21 is a PAN-based carbon fiber. Another example of the carbon fiber 21 is a pitch-based carbon fiber. While the carbon fibers can also be chopped fibers or milled fibers in the second embodiment, continuous fibers are preferable since the orientation direction of the fibers can be controlled with ease. In cases where the carbon fibers are chopped fibers or milled fibers, it is desirable to select the fiber length depending on the wavelength of the terahertz waves. However, in order to deal with all frequencies of terahertz waves, the length of the carbon fiber relative to the diameter (of the carbon fiber is desired to be greater than or equal to 10 times to obtain an excellent polarization property. With the polarizer 2 according to the second embodiment, a plurality of carbon fibers 21 are embedded in the plastic part 22 and no object or human makes contact with a carbon fiber 21, and thus cutting of a carbon fiber 21 is unlikely to occur and the displacement between carbon fibers 21 is unlikely to occur.

Further, the diameter Φ of each of the plurality of carbon fibers 21 is desired to be in a range from 5 μm to 15 μm. With such a diameter, the interval between carbon fibers 21 adjacent to each other in the polarizer 2 and the interval between parts of the plastic part 22 adjacent to each other across a carbon fiber can both be set less than or equal to a ¼ wavelength in regard to the wavelength of the terahertz waves. Further, the PAN-based carbon fibers as continuous fibers and the pitch-based carbon fibers as continuous fibers, currently in practical use as structural carbon fibers, have a diameter in this range, and thus are suitable for mass production. A volume content rate of the carbon fibers 21 relative to the polarizer 2 is desired to be in a range of 1% to 75%. In the second embodiment, the volume content rate is the ratio of the volume of the plurality of carbon fibers 21 relative to the sum total of the volume of the plurality of carbon fibers 21 and the volume of the plastic part 22. This volume content rate is desired to be set depending on the wavelength of the terahertz waves. This volume content rate is in a range of 55% to 75% in cases where a prepreg is molded by applying pressure thereto, and thus the productivity can be increased by using the prepreg. The volume content rate of carbon fibers mentioned here is the volume content rate Vf obtained by the combustion method stipulated in JIS (Japanese Industrial Standards) K7075-1991 “Testing Methods for Carbon Fiber Content and Void Content of Carbon Fiber Reinforced Plastics”.

The plastic part 22 is desired to be made with a material having a high insulation property. The polarization property deteriorates when electrically conductive plastic or plastic with electrically conductive filler added thereto is used as the plastic part 22. From the viewpoint of the polarization property, the plastic part 22 is desired to be made with plastic having a low dielectric constant and a low dielectric loss tangent. The plastic part 22 may be made with either thermosetting resin or thermoplastic resin. From the viewpoint of formability, it is preferable that the plastic part 22 be made with thermosetting epoxy resin which easily turns into a prepreg, excels in formability in a semi-cured state according to the die, and has a low dielectric constant.

Specifically, when the plastic part 22 contains epoxy resin, the specific inductive capacity is 3.2 to 4.0 and the loss tangent tan δ is 0.002 to 0.05. Since the specific inductive capacity is low and the loss tangent tan δ is low, the plastic part 22 containing epoxy resin is preferable from the viewpoint of the polarization property. Besides epoxy resin, the material of the plastic part 22 can also be vinyl ester, unsaturated polyester, furan, polyurethane, polyimide, polyamide, polyether ether ketone, polyethersulfone, polypropylene, polyester, polycarbonate, acrylonitrile styrene, acrylonitrile butadiene styrene, or modified polyphenylene ether, with which excellent performance can be obtained. Further, in order to obtain desired performance in terms of the strength, rigidity, thermal conductivity and the thermal expansion coefficient, an additive or filler made with a material not impairing the insulation property may be mixed into the resin. Incidentally, the dielectric constant and the dielectric loss tangent are dielectric properties in response to electromagnetic waves in the terahertz band. Since a measurement device for measuring the dielectric constant and the dielectric loss tangent is not commercially available, the dielectric constant and the dielectric loss tangent measured at 10 GHz or higher by the cavity resonance method described in JIS R1641 “Measurement Method for Dielectric of Fine Ceramic Plates at Microwave Frequency” may be used instead. Here, the specific inductive capacity means the ratio of the dielectric constant relative to the dielectric constant of vacuum.

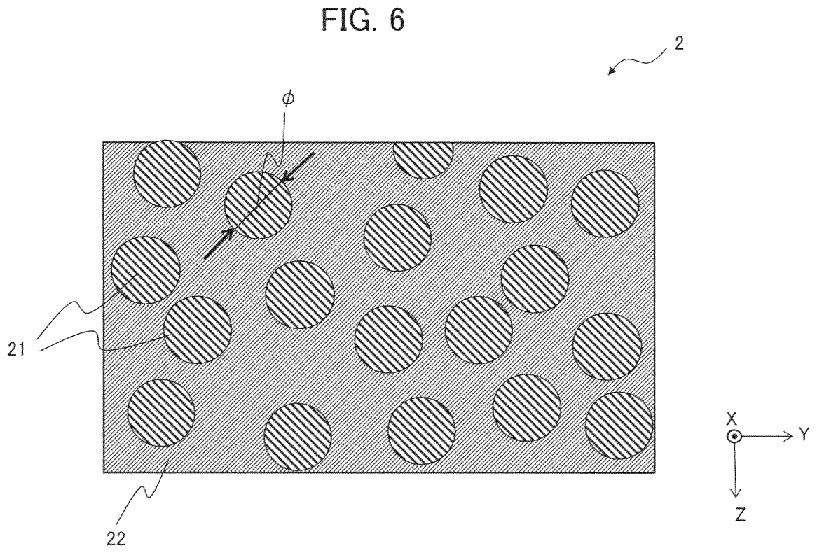

FIG. 6 is a schematic cross-sectional view of the polarizer 2 in FIG. 5 taken along the line VI-VI in FIG. 5. That is, FIG. 6 shows a cross section parallel to a Y-Z plane. The state in which the plurality of carbon fibers 21 have been embedded in the plastic part 22 is shown in FIG. 6. The plurality of carbon fibers 21 are not arrayed at even intervals, and the interval between adjacent carbon fibers 21 is not constant but random. Further, the plurality of carbon fibers 21 in FIG. 6 respectively have components extending in the X direction. That is, the orientation direction of the plurality of carbon fibers 21 has a component in the X direction. It has been confirmed that the polarizer has an excellent polarization property even when the plurality of carbon fibers 21 are not arrayed at even intervals as above. Further, it is permissible either all of the plurality of carbon fibers 21 are embedded in the plastic part 22 or some of the carbon fibers 21 are exposed to the surface of the plastic part 22. Furthermore, a permissible range of the orientation, namely, a permissible range of the extending direction of the carbon fibers 21, is a range from −7° to +7° when a direction in which the polarization property is the most excellent is defined as ±0°. That is, an excellent polarization property can be obtained if the carbon fibers 21 are pointed in directions in the range from −7° to +7°. Moreover, the polarizer 2 excels in the productivity since the polarizer 2 can be manufactured by a molding method using a prepreg.

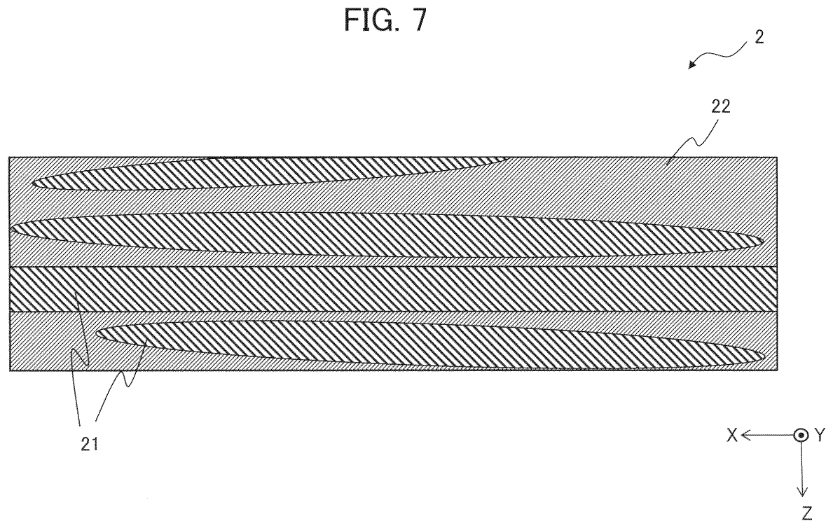

FIG. 7 is a schematic cross-sectional view of the polarizer 2 in FIG. 5 taken along the line VII-VII in FIG. 5. That is, FIG. 7 shows a cross section parallel to an X-Z plane. The state in which the plurality of carbon fibers 21 are embedded in the plastic part 22 is shown in FIG. 6. The plurality of carbon fibers 21 are not arrayed at even intervals, and the interval between adjacent carbon fibers 21 is not constant but random. Further, the plurality of carbon fibers 21 in FIG. 7 each have components extending in the X direction. That is, the orientation direction of the plurality of carbon fibers has a component in the X direction. In FIG. 7, the orientation direction of the carbon fibers 21 is set in the range from −7° to +7°. Therefore, the carbon fibers 21 include those whose cross section looks like a rectangle and those whose cross section looks like an ellipse. Further, the carbon fibers 21 include those inclined with respect to the X direction and those exposed to the surface. That is, an excellent polarization property can be obtained if the carbon fibers 21 are pointed in directions in the range from −7° to +7°.

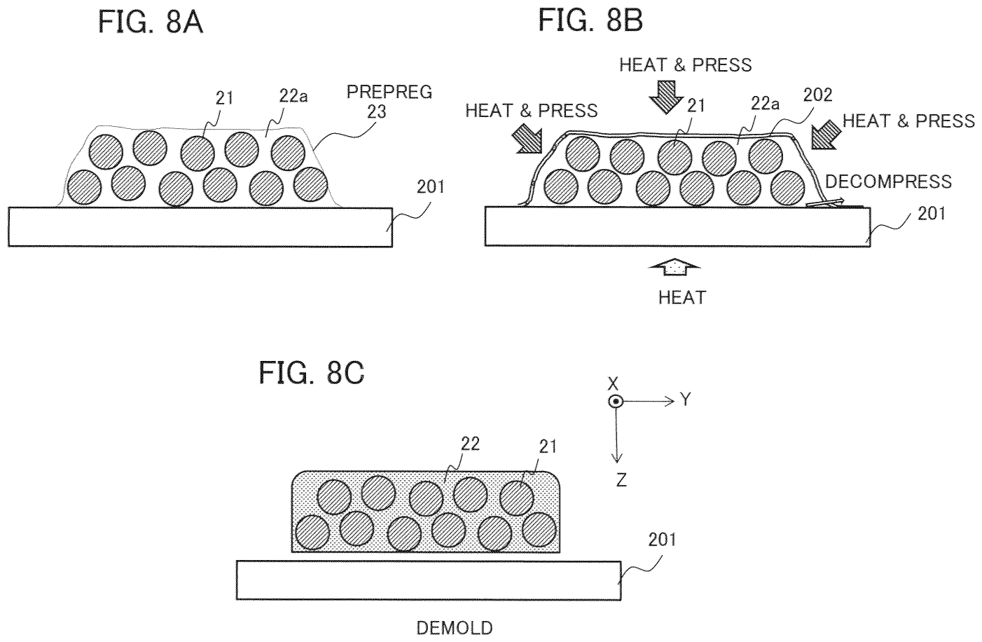

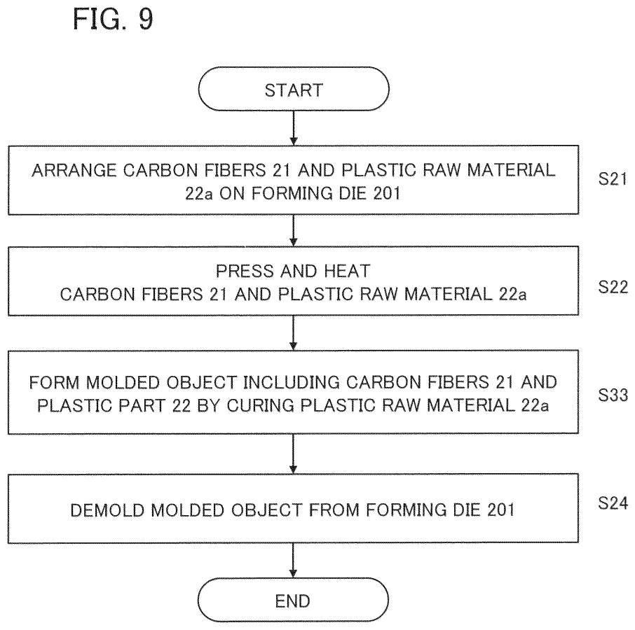

FIGS. 8A to 8C are schematic cross-sectional views showing an example of a manufacturing method of the polarizer 2 according to the second embodiment. FIG. 9 is a flowchart showing the example of the manufacturing method of the polarizer 2. The manufacture of the polarizer 2 is carried out automatically by manufacturing equipment, for example.

First, as shown in FIG. 8A, a plurality of carbon fibers 21 and a plastic raw material 22a are arranged on a forming die 201 (step S21). In FIG. 8A, the plurality of carbon fibers 21 are like wires and are arranged so that the plurality of carbon fibers 21 respectively include parts extending in the same direction (the X direction in FIG. 8A). By previously processing the forming die 201 to have a formation surface in a target shape, the plastic raw material 22a can be formed into an intended shape.

While the arrangement of the plurality of carbon fibers 21 on the forming die 201 and the arrangement of the plastic raw material 22a on the forming die 201 may be carried out at the same time, it is also possible to carry out the arrangement in order of the arrangement of the plurality of carbon fibers 21 and the arrangement of the plastic raw material 22a or in reverse order. Further, it is also possible to arrange the carbon fibers 21 and the plastic raw material 22a at the same time as a prepreg 23 obtained by previously impregnating the carbon fibers 21 with the plastic raw material 22a. The use of the prepreg is preferable since the volume content rate of the carbon fibers 21 can be controlled. Further, the method using the prepreg excels in the productivity since the carbon fibers 21 are covered with the plastic raw material 22a during the manufacture and the cutting of a carbon fiber 21 is unlikely to occur in the manufacture.

Subsequently, as shown in FIG. 8B, the plurality of carbon fibers 21 and the plastic raw material 22a arranged on the forming die 201 are covered with a vacuum bag 202, internal pressure of the vacuum bag 202 is lowered by using a vacuum pump, and pressure is applied to the carbon fibers 21 and the plastic raw material 22a by use of atmospheric pressure. Further, heating and pressing are executed by raising the temperature and the pressure of air outside the vacuum bag 202 (step S22). This method is referred to as an autoclave method. However, it is also possible to use a pressing machine for the application of pressure.

Subsequently, as shown in FIG. 8C, a molded object including the plurality of carbon fibers 21 and the plastic part 22 is formed by curing the plurality of carbon fibers 21 and the molded plastic raw material 22a (step S23). As methods for curing the plastic raw material (or the prepreg), there are a method of heating, a method of generating heat by adding a catalyst, a method of adding an ultraviolet-curing material and curing by irradiation with ultraviolet rays, and so forth.

Subsequently, as shown in FIG. 8C, demolding is performed as a step of removing the vacuum bag 202 and the forming die 201 from the molded object including the plurality of carbon fibers 21 and the plastic part 22 (step S24). The polarizer 2 can be manufactured by the above-described process.

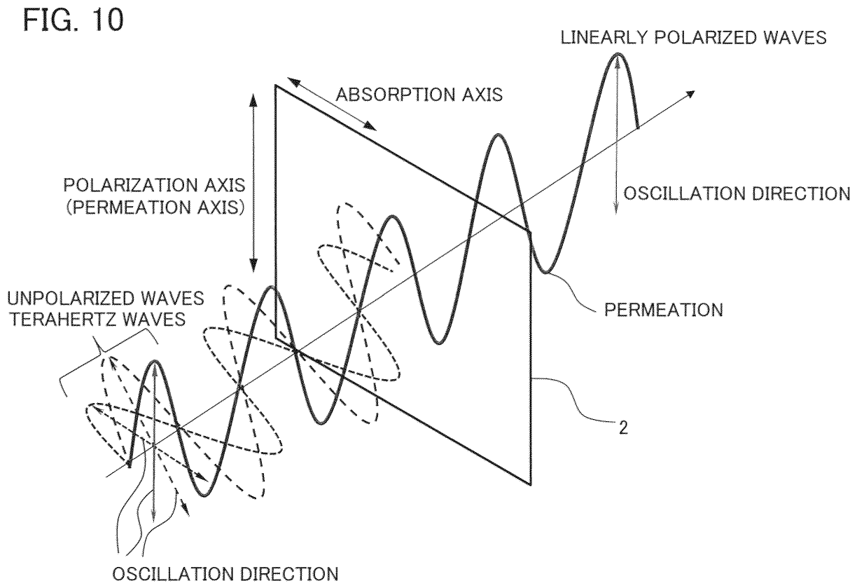

FIG. 10 is a diagram showing generation of linearly polarized light by the polarizer 2 according to the second embodiment. Terahertz waves oscillating in all directions (i.e., unpolarized waves) are split by the polarizer 2, and only terahertz waves oscillating in the vertical direction pass through the polarizer 2 and turn into linearly polarized waves. Most of the waves not passing through the polarizer 2 are reflected, and the rest of the waves are absorbed by the material and lost.

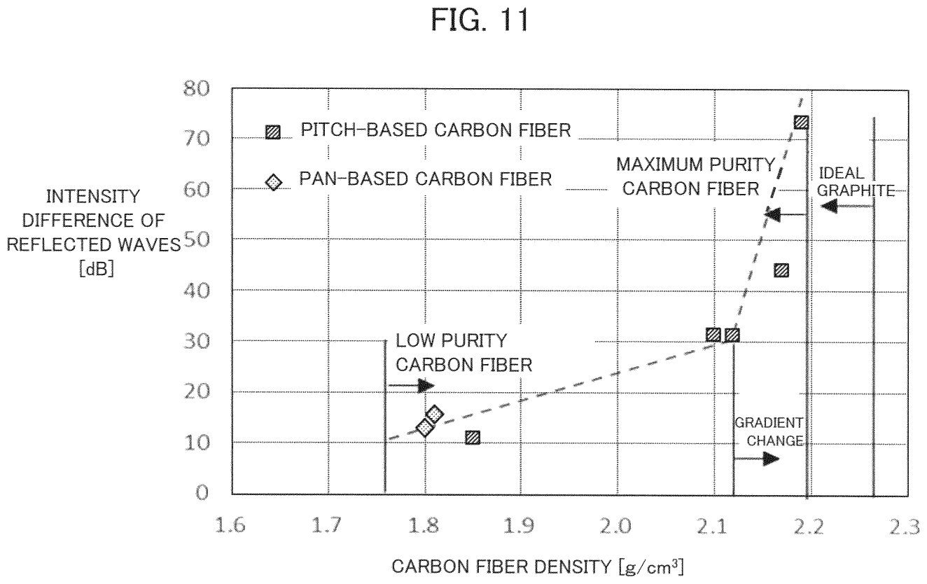

FIG. 11 is a diagram showing an experimental result indicating a relationship between the polarization property and carbon fiber density of the polarizer 2 according to the second embodiment and a tendency in the experimental result. Terahertz waves at the frequency of 0.3 Hz were applied to the polarizer 2 and reflected waves were detected while changing the density of the carbon fiber 21 in the polarizer 2. In the graph of FIG. 11, the vertical axis represents an intensity difference (Ax−Ay) in units of [dB] between intensity Ax and intensity Ay of terahertz waves as the reflected waves respectively having two axes orthogonal to each other, and this intensity difference (Ax−Ay) is used as an index of the polarization property of the polarizer 2. The polarization property improves with the increase in the density of the carbon fiber 21.

As for the density of the carbon fiber 21, 2.26 g/cm³ of ideal graphite is the realizable upper limit. While the lower limit is not particularly limited, carbon fibers with density higher than or equal to 1.76 g/cm³ can be produced stably. Further, pitch-based carbon fibers with density lower than or equal to 2.22 g/cm³ can be produced stably. The present inventors found out a tendency that the rise in the polarization property with the increase in the carbon fiber density becomes steep at 2.10 g/cm³.

Based on the above-described facts, it is desirable that the density of the carbon fiber be higher than or equal to 1.76 g/cm³ and lower than or equal to 2.26 g/cm³. Further, it is more desirable that the density of the carbon fiber be in a range from 2.10 g/cm³ to 2.22 g/cm³. Furthermore, it is the most desirable that the density of the carbon fiber be 2.22 g/cm³. The density of the carbon fiber mentioned here is density that can be measured by a method out of a liquid replacement method, a sink-float method, a density gradient tube method and a pycnometer method stipulated in JIS R7603: 1999 “Carbon Fiber—Determination of Density”.

The polarizer 2 according to the second embodiment includes the plurality of carbon fibers 21 fixed by the plastic part 22, and thus the strength can be increased and the polarizer 2 is unlikely to be damaged. Therefore, the polarizer 2 is capable of maintaining a stable polarization property.

Further, the carbon fibers 21 of the polarizer 2 are embedded in the plastic part 22 and no object or human can make contact with a carbon fiber 21 as an electrically conductive part, and thus a failure is unlikely to occur.

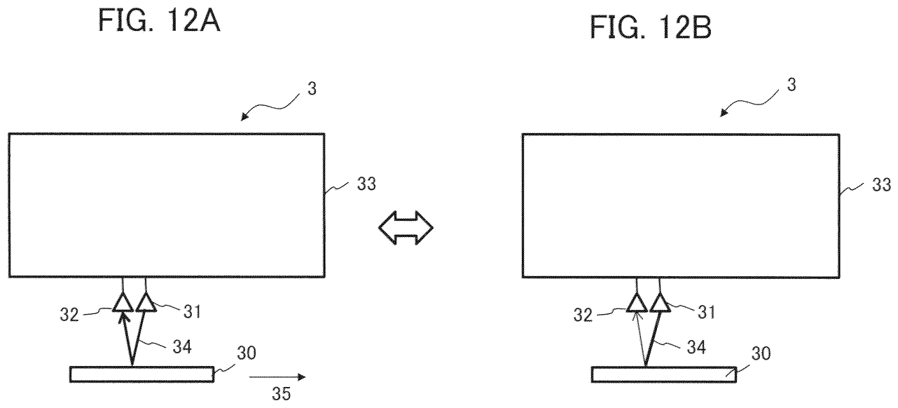

FIGS. 12A and 12B are diagrams showing the configuration of an encoder 3 as a polarizer application device according to a third embodiment. The encoder 3 includes a polarizer 30, a transmitter 31 that transmits terahertz waves 34 as electromagnetic waves, a receiver 32 as a sensor that receives the terahertz waves reflected by the polarizer 30 (or passing through the polarizer 30), and an arithmetic unit 33. The arithmetic unit 33 is an arithmetic circuit or a circuit including an information processing processor. Functions of the arithmetic unit 33 may also be implemented by a computer. The polarizer 30 includes one or more polarizers 1 or 2 described in the first or second embodiment, and the description here will be given of the polarizer 30 formed by using a plurality of polarizers 2 described in the second embodiment (hereinafter referred to also as polarizers 2a and 2b).

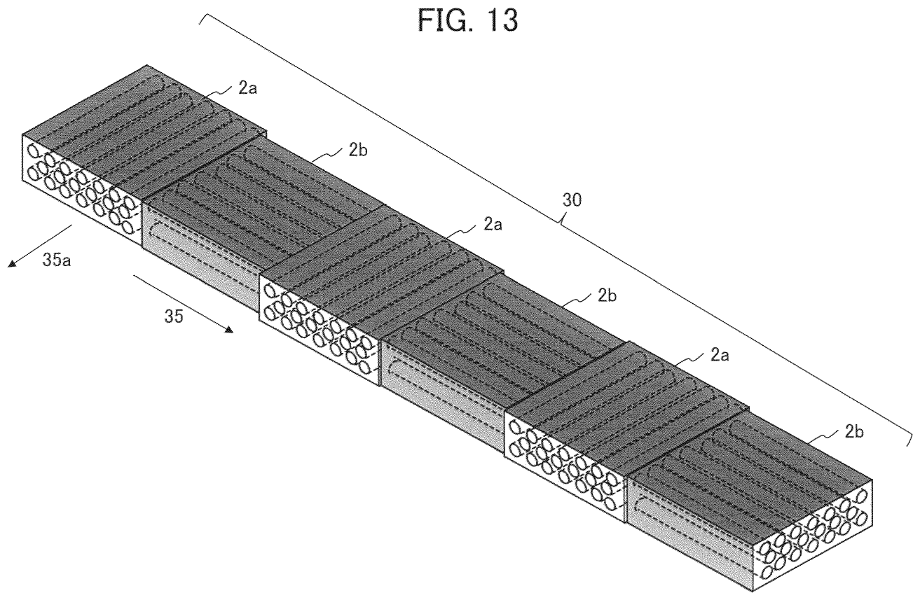

FIG. 13 is a perspective view showing detailed structure of the polarizer 30. The polarizer 30 has structure in which sections (i.e., polarizer 2b parts) in which the direction of the carbon fibers is parallel to a moving direction 35 and sections (i.e., polarizer 2a parts) in which the direction of the carbon fibers is a direction 35a orthogonal to the moving direction 35 are arranged alternately in the moving direction 35. Accordingly, the polarizer 30 has structure for reflecting terahertz waves 34 at a particular phase depending on the position in the moving direction 35. When the polarizer 30 moves in the moving direction 35 or in the opposite direction between the position in FIG. 12A and the position in FIG. 12B, the intensity of reflection components of terahertz waves at a particular phase received by the receiver 32 changes. The arithmetic unit 33 is capable of outputting a signal obtained by encoding the movement of the polarizer 30 based on a detection signal from the receiver 32.

It is also possible to arrange the receiver 32 at a position for detecting linearly polarized waves that passed through the polarizer 30.

Even if an object makes contact with the moving polarizer 30 while it is moving, a failure is unlikely to occur since the strength of the carbon fibers forming the polarizer 30 is high.

Incidentally, besides the encoder, examples of the polarizer application device include a position detection device, a shape measurement device and so forth. The polarizer application device employing the polarizer 1 or 2 is capable of stably making use of polarized waves of terahertz waves. Further, with the polarizer application device employing the polarizer 1 or 2, the productivity of devices can be increased.

### DESCRIPTION OF REFERENCE CHARACTERS

1, 2: polarizer, 3: encoder (polarizer application device), 11, 21: carbon fiber, 12: holding member, 13: first member, 13a: groove, 14: second member, 22: plastic part, 22a: plastic raw material, 23: prepreg, 30: polarizer, 31: transmitter, 32: receiver, 33: arithmetic unit, 34: terahertz wave (electromagnetic wave), 101a, 101b: lower die, 102a, 102b: upper die.

1. A polarizer that polarizes electromagnetic waves, comprising:
a plurality of carbon fibers; and
a holder to hold the plurality of carbon fibers in a state of being arranged with spacing between each other,
wherein
the plurality of carbon fibers respectively include parts extending in a same direction,
the holder includes a holding member to hold parts of the plurality of carbon fibers nearby ends thereof, and
the holding member includes
a first member having a plurality of grooves respectively positioning the parts of the plurality of carbon fibers nearby ends thereof, and
a second member to fix the plurality of carbon fibers in the plurality of grooves.

2.-3. (canceled)

4. A polarizer that polarizes electromagnetic waves, comprising:
a plurality of carbon fibers; and
a holder to hold the plurality of carbon fibers in a state of being arranged with spacing between each other,
wherein
the plurality of carbon fibers respectively include parts extending in a same direction,
the holder includes a plastic part to keep the plurality of carbon fibers embedded therein, and
the plastic part contains thermosetting resin.

5. (canceled)

6. The polarizer according to claim 4, wherein a volume content rate of the plurality of carbon fibers relative to the polarizer is in a range from 1% to 75%.

7. The polarizer according to claim 1, wherein a diameter of each of the plurality of carbon fibers is in a range from 5 μm to 15 μm.

8. The polarizer according to claim 1, wherein density of each of the plurality of carbon fibers is in a range from 1.76 g/cm³ to 2.26 g/cm³.

9. The polarizer according to claim 1, wherein the plurality of carbon fibers are pitch-based carbon fibers.

10. The polarizer according to claim 1, wherein the plurality of carbon fibers extend in a direction parallel to a polarization axis.

11. The polarizer according to claim 1, wherein the electromagnetic waves are terahertz waves.

12. (canceled)

13. A manufacturing method of a polarizer that polarizes electromagnetic waves, comprising:
arranging a plurality of carbon fibers oriented to respectively include parts extending in a same direction and a plastic raw material containing thermosetting resin on a forming die;
molding the plastic raw material by applying pressure to the plurality of carbon fibers and the plastic raw material arranged on the forming die;
forming a molded object including the plurality of carbon fibers and a plastic part filling in spaces around the plurality of carbon fibers by heating and curing the molded plastic raw material; and
demolding the molded object from the forming die.

14. The manufacturing method of a polarizer according to claim 13, wherein the arranging the plurality of carbon fibers and the plastic raw material includes arranging a prepreg obtained by impregnating the plurality of carbon fibers with the plastic raw material, on the forming die.

15. A polarizer application device comprising:
the polarizer according to claim 1;
a transmitter to apply electromagnetic waves to the polarizer; and
a receiver to receive the electromagnetic waves after passing through the polarizer or after being reflected by the polarizer.
